(19) United States
(12) Patent Application Publication
(10) Pub. No.: US 2026/0327043 A1
(43) Pub. Date: Oct. 22, 2026

(54) TECHNIQUE FOR ESTIMATING AN ELONGATION OF SUSPENSION MEANS OF AN ELEVATOR CAR

(71) Applicant: Inventio AG, Hergiswil (CH)

(72) Inventors: Michael Vogt, Berlin (DE); Florian Dold, Cham (CH); Adolf Bissig, Buochs (CH)

(21) Appl. No.: 19/109,584

(22) PCT Filed: Sep. 13, 2023
(86) PCT No.: PCT/EP2023/075128

§ 371 Date: Mar. 7, 2025

(30) Foreign Application Priority Data
Sep. 15, 2022 (EP) 22195809.3

(51) Int. Cl. B66B 7/12; B66B 3/00

(52) U.S. Cl. CPC B66B 7/1215; B66B 3/002

(57) ABSTRACT

A technique for estimating an elongation of a suspension means of an elevator car includes deriving a vibrational property of a system formed by the car and the suspension means based on a measurement of oscillating position variations resulting when the car is temporarily accelerated. Then the elongation of the suspension means is estimated based on the vibrational property.

### FIELD

The present invention relates to a method for estimating an elongation of suspension means of an elevator car. Further the invention relates to a system for estimating an elongation of suspension means of an elevator car, as well as to a corresponding computer program product and computer readable storage medium.

### BACKGROUND

An elevator system or elevator is understood herein as a system capable of transporting persons and/or goods, loads or freights in a moving car, cabin, cage, platform, etc. in a vertical or inclined direction between two or more levels, e.g., floors. The car hangs on suspension means such as one or more ropes, belts, chains, or combinations thereof. For example, a rope may have one of its ends fixed to the car, another end fixed to a counterweight, and is driven and/or guided by a driving sheave or traction sheave.

Ropes and any kinds of suspension means are subject to aging, wearing, etc. and are to be replaced on inspection of various properties such as including monitoring and control of tension, twisting, diameter thinning, corrosion, loosening of strands, brittle fractures, etc. As inspections by personnel are costly, there is a general need for further monitoring which can complement the personal inspections, for example which may allow early scheduling of maintenance, service and repair, if necessary.

A manifold of sensor equipment may be provided by a manufacturer of an elevator system built-in or integrated with or into the car, driving engine, traction wheel, etc. and may provide data related to state and operation of an elevator system. Such data may be stored locally, e.g., associated with a local control unit of the elevator system such as to be read out by local personnel, and/or may be transmitted to a remote control center.

Various parties may be involved in management, operation and control of an elevator system. Commonly, an elevator may be operated by a management company of the property of which the elevator is part of, while maintenance is under the responsibility of an associated service company, which may be a subsidiary of the manufacturer of the elevator system or which may be an independent company, having some contractual relationship with the manufacturer. In frequent cases a service company does not have full access to the sensory equipment of the elevator system as provided by the manufacturer and the corresponding data. The service company then faces the task to get the required data. This may include installing its own sensors and establishing a proprietary management of monitoring, maintenance, etc.

In a more specific example, a manufacturer will normally provide extensive sensor equipment for monitoring a state of a rope or other suspension means. If a service provider has limited access to such suspension means monitoring system, there is a need for a substitute or supplementary system which can measure important parameters of the rope.

### SUMMARY

Accordingly, there is a need for methods for estimating a state of an elevator system, specifically suspension means thereof. There is further a need to establish such state in case of limited access to built-in sensory equipment. There is further a need for a monitoring system based on such approaches, where such system may act as a supplementary monitoring system, such as a secondary or backup system for plausibility checks or in case of failure of a built-in measurement system, or in case a service company has to establish its own, proprietary monitoring system. There is also a need for such approaches and systems which enable a cost-efficient and/or remote monitoring of the elevator and its suspension means. Still further there is a need for corresponding computer programs and computer readable media for implementing such methods and systems.

At least one or more of these and other needs are met by the subject-matter as defined in the advantageous embodiments discussed in the following specification.

According to a first aspect of the present invention, a method for estimating an elongation of a suspension means of an elevator car is proposed. The method comprises deriving a vibrational property of a vibrating system formed by the car and the suspension means based on a measurement of oscillating position variations resulting upon the car being temporarily accelerated; and estimating the elongation of the suspension means based on the vibrational property.

The term “car” as used herein is to be understood as including, besides cars or cabins also cages, platforms and any other means suitable for transporting persons and/or other loads such as goods, freight, etc.

The suspension means or traction means can comprise one or more ropes, cables, chains, belts, combinations thereof, etc. Occasionally herein, for sake of conciseness, only a “rope” may be referred to; however, this term is to be understood as including any kind of suspension means, traction means, suspension/traction means etc., unless explicitly stated otherwise.

An elongation of the suspension means may comprise any kind of tension, strain, stretching, lengthening, extension, expansion, capability therefore, in particular in an elastic manner, etc. thereof. A stiffness or rigidity of the suspension means may be understood as a complementary property being in correlation with the elongation of the suspension means, i.e. elongation and stiffness may be convertible into each other, and in this sense the terms “elongation” and “stiffness” are understood as being interchangeable herein. In case the suspension means comprises multiple ropes, cables, etc., each rope can have assigned its individual elongation or stiffness, and the ensemble or set of all ropes (and any subset thereof) can have assigned an corresponding (sub-) set elongation or stiffness.

The vibrational or vibrating system formed by the car and the suspension means is to be considered specifically as including those part or parts or portions of the suspension means which may be excited to vibrations, and this may in particular include the part of the rope or suspension means which extends between one or more fixing points thereof at the car and a sheave which releases or receives the rope, for example at a top of an elevator shaft, such as a traction sheave, deflection sheave, rope or cable drum, etc. Other parts of the rope may also contribute to vibrational or elastic properties of the system, e.g., behavior of the rope extending on the other side of the sheave may be transmitted by the sheave towards the car. This is however not to be understood as excluding other or further influences which may contribute to the vibrational properties of the vibrational system. For example, the sheave or drum may itself tend to vibrations such as rolling slightly back and forth when the driving engine stops, a bearing or mounting of the sheave may show vibrations, and also an attachment of the suspension means to the car may tend to vibrations.

In more detail, the system formed by the car and the suspension means may be considered a vibrational system based on any elastic properties of that system, in particular one or more elastic properties of the suspension means. Such properties may result in movements of the system, in particular small-scale movements. More specifically, the car may move between floors when the car is actively driven but there may be further positions and changes thereof and movements during active drive and when not being actively driven, for example when stopping at a floor. Purely for purposes of illustration one may consider “large-scale movements” such as actively driven movements or movements between floors, which may typically be measured in m (meters) or floors or other kinds of levels, while “small-scale movements” may refer to movements of the car which occur, in principle, due to the above-indicated elastic properties of the car/rope system, and such small-scale movements of the car may typically be in the range of centimetres (cm) or millimetres (mm), for example.

The small-scale movements may in particular comprise oscillations, more precisely oscillating position variations of the car, which result from the car being excited, for example, by the car stopping, e.g., more or less abruptly, doors opening or closing, a person or persons entering or leaving, a person putting down luggage, freight being deposited, the traction sheave stopping and rolling slightly back and forth, etc. Any such excitation event can be understood as a force impact acting to temporarily accelerate the car, specifically in a direction along the elevator shaft, parallel to the large-scale movements of the car, etc., where such impact may operate on a “short” timescale in comparison to timescales related to the large-scale movements when the car is driven between floors, for example, and “short” therefore is to be understood in the sense of “abrupt” or “sudden”. It is also to be noted that the temporary accelerations may result from excitations such as walking steps of a person and/or may result from the oscillating or vibrational response of the car/rope system to such excitations.

Measurements of oscillating position variations of the car are meant to include any kind of measurements of position, velocity, and/or acceleration of the car, which indicate a positional behavior of the car such as positions and changes thereof, which may be measured relative to an absolute reference such as related to an elevator shaft in which the car is moving, or a relative reference such as a stopping point or position which the car may approach by damped vibrations or oscillations around such point as reflected by the measurements. It is to be understood that such measurements and behavior as of interest may relate to vertical movements (i.e., in parallel to a force of gravity), for example in a direction up or down in a vertical elevator shaft, which does not exclude measurements and behavior of the car in elevator constructions deviating from purely vertical arrangements.

The above discussion is not meant to be limiting with regard to further sources of small-scale movements of the car such as, for example, from oscillations of the building. However, it is considered that technical effects and advantages of the invention can be understood and achieved without detailed reference to such further influences. For example, the contributions of these further influences may be deemed small compared to what is discussed elsewhere herein and/or may cancel out when changes in a vibrational property of the vibrational system are to be determined, and it may be deemed advantageous to make use of other trigger events such as resonant excitations for triggering the measurements, if such can be identified.

Purely for sake of conciseness, the system comprised by the car and the suspension means is occasionally simply referred to as “car/rope system” herein. Similarly, the vibrational properties of such system are occasionally only referred to as the “vibrational properties of the car”, and it is to be understood that what is meant here are the vibrational properties of the car and the suspension means (any kind of suspension means). This is also clear from the view that normally the car itself or as such may not be considered to have vibrational properties which would be relevant for the present discussion.

The positional behavior of the car such as including in particular the oscillating position variations thereof can be measured by one or more position sensors, a position measurement system, position detection system, ranging system, distance measuring, etc., but also velocity sensors and/or acceleration sensors, for example. The skilled person is aware of the rich variety of sensory equipment available in this regard. As but one example, an acceleration sensor or a vibration sensor can be employed with a sensitivity sufficient for measuring the accelerations of the car resulting in/from the above-discussed small-scale movements, where such accelerations may typically be in the range of tens of mm/s² (millimetres per second to the 2^{nd} power), for example.

As another example, the elevator may be configured for re-levelling, i.e. correcting or adapting the position of the car during a stop at a floor in response to a varying load of the car due to, e.g., people leaving or entering. It is to be understood that the operation of such re-levelling may result in oscillating position variations of the car in discrete steps of, for example, +1 mm or −1 mm. A measurement of the positional behavior of the car for the purpose of the present invention may comprise retrieving the according positional indications from a re-levelling control/management system, for example, or measuring the positional adaptions in any other, e.g., proprietary way.

Movements of the car, for example small-scale movements in the range of mm or according accelerations, may be measured preferably directly at the car to achieve a desired accuracy as compared to, for example, placing a sensor at some intermediate point of the rope or near to the sheave. For example, a measurement sensor can be arranged on a top or roof of the car, or below a bottom or floor thereof. A positioning sensor such as an active or passive optical sensor, infrared or lidar sensor, radar sensor, ultrasound sensor, etc. may measure a position of the car relative to an elevator shaft, where it is noted that such measurement may be performed in a vertical or inclined direction, i.e. along the shaft, or in a horizontal direction, e.g. with regard to small-scale or fine-graded positional indications arranged in the elevator shaft at a stopping position at each floor.

As another example, an accelerometer or acceleration sensor may preferably be arranged near to a fixing point at a car roof where the car is attached or mounted or otherwise engaging with the rope or one of the ropes or generally the suspension means for the suspension/traction of the car. While one may assume that this can optimize an accuracy of the measurements, other suitable places to arrange the sensor can also be contemplated, for example at or with a view onto the rope, in an intermediate top or bottom of the car, or even in an interior of the car. For example, an accelerometer can be arranged inside the car, at a side wall or under the roof or under a floor of the car. One reason why an accelerometer may be considered preferable over other positional sensor equipment can be that the accelerometer can be freely arranged anywhere at or in the car (or the rope near the car). However, some places such as an interior floor or panels etc. of the car may be prone to secondary vibrations which may obscure the measurements.

The sensory equipment for the measurement of oscillating position variations of the car may comprise multiple sensors. For example, in case the suspension means comprises multiple ropes, belts, etc., an accelerometer may be arranged at or near each associated fixing point at the car. The data provided by multiple sensors may be processed per sensor, or may be processed to average the multiple measurements, perform error correction, etc., and such may enable to, for example, correct for influences resulting from small-scale movements of the car in the elevator shaft, vibrations of attachments at the one or more fixing points of the rope/s, etc.

The terms “vibrational” and “oscillational” are used synonymously herein. Calculating or determining a vibrational or oscillational property of the car/rope system can comprise calculating or determining a vibration frequency, a vibration amplitude, and/or further properties such as a vibration (oscillation) time, an angular frequency, an energy of the oscillation, etc., but also an envelope for the measured amplitude over the measurement time, etc.

The vibration or oscillation frequency of the car may also be referred to as a bouncing frequency, which may be in view of an elevator shaft and the movement of the car therein being arranged vertically (i.e., parallel to a gravitational force), and these terms may therefore also be used interchangeably herein. This is not to be misunderstood as excluding elevator shafts (and car movements) which are not arranged strictly vertically.

A vibration or oscillation frequency of the car may be regarded a resonance frequency (or a natural or eigen frequency) of the car/rope system, as will be discussed further below, and these terms may therefore be used interchangeably herein. It is not intended that usage of such terms limits the present invention with regard to any particular physical interpretation or modelling.

The terms “determining” and “estimating” may also be used synonymously herein. It is to be understood that in view of a complexity of the measured vibrational system as discussed herein throughout, as well as the measurements itself and analysis thereof, the determination of a vibrational property (or change thereof) and accordingly a rope elongation (or change thereof) may provide useful results, however with a limited accuracy according to design of the determination/estimation system, cost-efficiency, etc. It is however not intended that use of any such terminology may limit the invention or preclude technical effects or advantages thereof.

Estimating a rope elongation from the derived vibrational property of the car/rope system may comprise referring to any given relationship between elongation and vibrational property, wherein such relationship may be represented as a formula or equation, in tables, databases, combinations thereof, etc., and wherein such relationship may be based on theoretical modelling, measurements, experiences, etc. Any such relationships may be generally applicable, or specifically for the given rope, rope model, type, or series, etc.

Estimating a rope elongation may comprise estimating a change in the elongation, specifically from a change in the derived vibrational property of the car/rope system. For example, determining or estimating a change of the vibrational property of the car/rope system can comprise analysing and comparing multiple, i.e., two or more measurements of oscillating position variations of the car, and one or more of the correspondingly calculated vibrational properties. For example, a change in frequency, an amplitude, an envelope for the amplitude etc. can be determined or estimated.

Multiple measurements of oscillating position variations to be combined, compared or otherwise be included in the estimation may have one or more properties in common for a meaningful analysis. It is noted that any such measurements may result from being stipulated or triggered by same or similar trigger conditions, and/or may be identified in available measurement data to be similar in desired configurations, properties, etc.

For example, measurements may be related to each other which, as far as possible, are taken by the same sensors or sensor equipment, under comparable operation conditions of the sensors such as, e.g., a sampling frequency, a measurement or sampling time, accuracy, sensor-internal error correction, a software/firmware version of the sensor, etc.

As a further example, a change in elongation or stiffness may preferably be estimated based on measurements where the car has a same mass or weight, such as the car is the same or a similar model or type, series, etc., an equipment thereof is similar, such as an interior equipment, e.g., a wall covering, metal or glass labelling, mirrors, etc., also including the same or similar internal doors, but also with regard to external equipment such as assemblies on the roof or below the floor etc.

Moreover, it may be intended that for measurements to be related to each other, a car load should be same or similar. A “load” of the car or “car load” or “cabin load” is understood as a payload, loading capacity, workload, etc. which is carried by the car or cabin. More specifically, the load may comprise the person or persons or passengers and/or freight with which the car is loaded. Such load may be indicated as a mass or weight, for example in kg (kilogram) or t (tons), or as a number of persons (wherein a “person” may have an assumed average weight), or as a fraction of an allowable total or maximum load.

As a specific example, measurements may be related to each other where the operation of the elevator comprises entry of a person into the car, such as entry of a first or single person into an empty car, or exit of a person from the car, such as exit of a single or last person from the car.

In practice, measurements differ from each other, as, e.g., persons have different weight, carry or not luggage with them, etc. For measurements to be relatable to each other, car loads may be seen as “similar” or “comparable” if the differences in weight are small compared to a total weight of, e.g., the empty car, the system of car and rope, etc., where “small” may mean some fraction such as less than 25% of the total weight, preferably less than 10%, more preferably less than 3%, most preferably less than 1%. It is also to be understood that the issue of “similar” or “comparable” loads or “small” differences also depends on the intended accuracy of the results, i.e. the estimated rope elongation or stiffness, or changes thereof.

According to another example, measurements may be related to each other which are performed at a same or nearby floor (or other kind of level). For example, where a measurement may be performed when the car stops at a floor “N”, for example at a floor “1” or “10” or “30” or “100” or “−10”, such measurement may be compared to other measurements made at the same floor N, or (for example, in case no such measurement is available) at a nearby floor, such as at N+1, N−3, etc.

The term “nearby” can be understood as defining a group of floors expectably having comparable vibrational properties of the car/rope system. For an example of a vibrational frequency of the car during a stop at a particular floor, measurements may be deemed comparable as long as the length (traction length) of the rope between a driving or traction sheave and the car is comparable. Specifically, “comparable” may relate to an accuracy of the estimation of rope elongation or stiffness which is desired or which can practically be reached. For example, if a change in a vibrational frequency or estimated car load between nearby floors can be expected to be below a given accuracy, such floors can be considered “nearby” and the associated measurements “comparable”.

In practice, a number of “nearby” floors may be small compared to a total number of floors, a total length of the elevator (elevator shaft) etc. For example, a given fraction of all floors may be considered to be “nearby” to each other, for example, 1/10 of all floors may be seen nearby to each other, or ⅕, or ¼, or ⅓, or ½ of all floors.

According to another practical example, traction lengths of the rope may be seen comparable to each other where the differences in length (between sheave and fixing point at the car) are 1/10, or ⅕, or ¼, or ⅓, or ½ of each other. It is however to be noted that examples can be contemplated, where, for example in case of a freight elevator, the length of the rope from a traction sheave to the car at the uppermost floor may be longer than the difference between the uppermost floor and the lowermost floor. For such example, measurements taken at all floors may be seen comparable, i.e. all floors are “nearby” to each other.

As another example, measurements can be repeated (and then related to each other) at timescales on which detectable changes in rope elongation or stiffness can be expected. Specifically, if it is considered that a rope state such as characterized by stiffness or elongation may change over timescales of months and years until after one or more years the rope is to be replaced, then a change in stiffness or elongation may be estimated from measurements performed with a time interval in between which is a reasonable fraction of the replacement timescale, wherein the term “reasonable” may relate to the intended accuracy of the estimation. For example, a rope state may be deemed constant on “short” time scales compared to a replacement time, and “short” may mean time intervals or time spans of 1 month or shorter for a replacement time of 1 year (yr), for example, or may mean measurement time intervals or time spans of 1 yr or shorter for a replacement time of 10 yr, or 25 yr, etc.

It is to be noted that, where the suspension means comprises multiple ropes, cables, etc. the replacement of only one of these may not considerably change the properties of the suspension means as a whole. In such cases it may be difficult to estimate a change in elongation of a single rope from measurements of the vibrational system comprising the entirety of the suspension means. However, in other cases, where all or a fraction of all ropes is replaced at a time, measurements can be expressive. For example, in a case where the suspension means comprises two ropes, and every few years one of the ropes is replaced in alternation, a state or an aging of the suspension means formed by the two ropes can be measured and measurements compared to each other when made at an interval of, e.g., 1 yr.

According to some embodiments, a car/rope system, more generally a vibrating or vibrational system formed by car and suspension means, can be considered a spring pendulum, spring oscillator or spring-mass system. Estimating an elongation or stiffness of the rope or suspension means can then be based on a spring-mass-vibration or oscillation formula or equation.

As an example, an equation as follows can be used:

$$f = \frac{1}{2 π} \sqrt{\frac{c}{m 1}} = \frac{1}{2 π} \sqrt{\frac{\frac{F}{ε}}{m 1}} ,$$

wherein f is the vibrational frequency of the system, c is a stiffness of the suspension means, m1 is the vibrating mass of the system, F is a force, and ε is an elongation of the suspension means.

It is to be noted that the oscillating mass m1 may include a (current) mass or weight of the car at the time of measurement, i.e. the mass of the car only in case of an empty car, or the mass of the car including a load if any person, freight etc. is in the car. Moreover, the mass m1 may comprise at least a fraction of the mass of the rope or ropes, for example as extending between traction sheave and car, if not the mass of the rope/s is negligible compared to the mass of the (loaded) car. The amount or fraction to which the rope is to be considered to contribute to the vibrating/oscillating system mass may vary between elevator systems, cars, etc. and may be determined based on, for example, tests, series of test measurements, tables, experiences, etc.

According to some embodiments, the vibrational frequency f can be used to estimate the stiffness c and/or elongation ε of the car/rope system, wherein the car may be assumed rigid such that stiffness c and elongation ε are that of the suspension means in the direction of suspension/movement of the car. In one example, a rope elongation can be determined from tables, databases etc. where values of (measured) oscillation frequency f are associated with or mapped to (effective) values of corresponding elongation ε/stiffness c. Such mapping may be prepared and provided based on test measurements, auxiliary measurements, theoretical calculations, experiences, etc. Instead of tables, equations or tools can be provided which compute, on entry of a measured frequency, optionally further parameters such as parameters related to the elevator, elevator system, rope, rope type, etc., as an output a corresponding or effective value for the elongation or stiffness.

It is recalled, as a specific example, that the elongation of the rope as estimated from the measured oscillating position variations of the car may not only be due to elastic properties of those portion of the rope which extends between its fixing point at the car to the (first) sheave, but the rope extends further on the other side of that sheave, and that further portion or portions of the rope may also contribute to the elongation as effectively measured and estimated. It may therefore be deemed preferable to perform test measurements, series thereof, for elevator types, systems, a specific elevator, etc. to represent complex behavior of the vibrating system in mappings, tables, equations etc., which then allow determining an effective elongation from a single measured frequency.

As a still further example, values for a stiffness or elongation of a free rope and portions thereof may be known, for example for a new rope, or may be measured for an old rope, e.g., after replacement. Further measurements are performed, as test measurements or during normal operation, where such rope is in use in a specific elevator system. The measured and estimated values for effective stiffness or elongation of the built-in rope can be associated with the stiffness and elongation values of the free rope, and such can be stored in a database, etc., which can then be used to estimate a “free” elongation or stiffness of a built-in rope as a parameter defining the state of the rope.

In the above formula, relevant changes for the spring constant or rope stiffness or elastic strain or elasticity c of the rope and/or the elongation, strain, or unit lengthening ε may be assumed on timescales of reasonable fractions of the replacement times, as discussed above, and such timescales may also be known from, e.g., theoretical considerations, tables, experiences, etc.

According to some embodiments, changes in the vibrational frequency f can be used to estimate changes in stiffness c and/or elongation ε of the car/rope system. In a specific example, a current elongation of a rope can be determined as follows: An estimated difference or change in the vibrational frequency f transforms into a difference or change in elongation ε in the absence of other variations, such as in (effective) mass m1 of the vibrating car/rope system. More specifically, measurements related or compared to each other may preferably be made with a same car, car load, and/or at a same given floor, as discussed above and elsewhere herein.

For example, measurements where an empty car responds to a single person entering may be preferable over measurements where a car filled with many persons responds to a further person entering, in order to minimize weight differences; however, test measurements could rely on standardized car loads. More generally, various differences in the measurements may be seen negligible, such as discussed for nearby floors, different car loads, etc. elsewhere herein. As a further example, a difference in rope length due to measurements at different (nearby) floors may be accounted for by a correction in the mass m1 in the above formula, as the mass of the rope extending between one floor, two floors, etc. may be approximately known.

Comparing a currently measured oscillation frequency to an earlier measured frequency may lead to a stiffness or elongation ratio. For example, such ratio may be understood as expressing a current stiffness/elongation in terms of, e.g., an initial stiffness/elongation when the rope was new. Such values may as such be taken as indications as to whether the rope has to be replaced from tables, maps, etc. provided by, e.g., a manufacturer of the rope etc.

According to some embodiments, an estimated change in stiffness or elongation can result in assigning a value for a current stiffness or elongation of the suspension means, and this may be based on, for example, relating many measurements, referring to guesses for resulting changes in vibrational frequency, knowledge of extreme values of vibration frequencies for new ropes, aged ropes, ropes to be replaced, etc., and such knowledge may be represented in mappings, tables, equations, computing tools, combinations thereof, etc., as discussed for the case of estimating an elongation/stiffness from a single measurement only.

As one specific example, a measurement taken for comparison may relate to an empty car, wherein the oscillation frequency thereof may relate to the empty car being excited to vibrations only by the car being stopped at a given floor, or by the empty car being excited to oscillations by a first or single person entering or exiting the car when the car stops at a given floor. Such measurements may preferably be arranged as a measurement campaign comprising measurements on all floors, e.g., once per year, resulting in a series of estimated elongations per floor, which may enable a more comprehensive overview on rope state than a single measurement on a given floor.

In a still further example, the measurement may relate to a non-zero car load, such as the car carrying multiple persons and/or one or more, specifically a last person entering the car. Such measurements may preferably be related to each other if measurements are to be taken during normal operation. For example, various measurements can be taken and stored in a database, from which measurements with comparable parameters can be identified, guessed, etc. and selected in a post-processing operation.

As discussed hereinabove, it is generally dependent on a desired accuracy of the stiffness/elongation estimation, which influences on the vibrational properties of the car/rope system are considered, which corrections applied or included in a formula such as that above, etc. As an example, depending on the intended accuracy, an estimated difference or change in a vibrational property such as the oscillation frequency f may be disregarded or discarded if the difference is below a given threshold, i.e., in such cases it may be determined that the current stiffness or elongation is essentially unchanged compared to that of the earlier measurement.

As discussed already above, a general approach for estimating a status of a rope according to its stiffness/elongation properties may include performing one or relating multiple series of measurements with other, wherein each series includes measurements at multiple floors, e.g., a subset of all floors. Measurements to be related to each other may also be weighted according to a degree of similarity, e.g., regarding same or neighboring floors, same or different load, etc., and an accordingly presumed accuracy of the estimations.

It is noted that estimating a current rope stiffness or elongation based on current or recent measurements in comparison to earlier measurements of, for example, 1 yr ago, 10 yr ago, combinations thereof, etc. is but one practical application of the present invention, where it is of course possible to compare or relate measurements with each other which are all made “earlier” with respect to the time of processing, for example to generate a timeline of measured/estimated rope elongations. For example, such approach may comprise batch processing of measurements stored in a database regarding one or more elevators, for classification according to buildings, rope manufactures, rope properties, etc. It is reminded that the intended accuracy of the stiffness/elongation estimation may depend on intended uses thereof, and for such statistical properties a limited accuracy as provided by a cost-efficient sensing and processing equipment may be sufficient.

According to embodiments of the invention, an indication of the estimated stiffness or elongation can be provided or forwarded to a monitoring and/or control system such as for maintenance control. For example, embodiments can assist, complement or replace a monitoring based on OEM sensory equipment of an elevator system. A stiffness/elongation estimation system according to the present invention can be provided, e.g., at an exterior of the car, at any time after the manufacture and installation of an elevator system and can operate entirely independent of any built-in sensing and monitoring system. Embodiments can therefore be used, for example, for monitoring an elevator system in case of limited access to a built-in monitoring system.

Embodiments of the present invention are particularly suited for remote monitoring. For example, one or more of the proposed derivation or estimation steps, actions or operations can be initiated, performed and/or controlled by a remote monitoring facility such as in an associated control or operation center. According to specific examples, while the start of a particular measurement may be triggered locally, e.g., by detection of an event indicating a car stopping, door opening, etc., remote signals or commands may activate, for example, a sensory equipment, a local trigger detection mechanism, etc. Remote signals may initiate and/or control local measurement campaigns covering measurements at a plurality of floors, for a given time such as, e.g., one hour, one day, etc. Data representing measurement results can be pushed to a remote repository for further processing or can be stored locally and accessed on demand from a remote monitoring center.

A derivation of vibrational properties can be performed locally and/or at a remote server or monitoring facility, depending, for example, on whether and which further data are accessed or retrieved, databases consulted, etc. Similarly, an estimation of stiffness or elongation can be performed locally or at a server. Generally, server-based or platform-based solutions may enable more complex derivation or estimation processing. As an example, a server may be configured to access databases storing, e.g., technical properties, parameters, etc. of elevator systems, specific elevators, of different manufacturers, etc. and may retrieve parameters as required for a specific measurement or measurement campaigns.

As another example, a server may be configured to access databases storing, e.g., earlier measurements, measurements of similar elevator systems, types, etc., in the same or similar buildings, etc., which may enable suitably selecting one or more earlier measurements for comparison with current measurements. Similarly, any kind of post-processing such as generating timelines of elongation per rope, rope type, model, etc., may also preferably be implemented at the server which may allow a service company building a knowledge database for the serviced facilities.

According to a further aspect of the present invention, a computer program product is proposed which comprises program code portions for at least one of performing and controlling one or more of the methods described herein when the computer program product is executed on one or more computing devices. Generally, embodiments of the various methods proposed herein can be computer-implemented. For example, any one or more steps may be executed in a processing unit such as a central processing unit, CPU, a microprocessor, controller, microcontroller, etc. Such processing unit may have memory associated therewith for storing control commands for execution of the computer program, such as cache memory.

According to another aspect of the present invention, the computer program product may be stored on a computer readable medium, such as a permanent or re-writeable memory within or associated with a computing device, such as flash memory, ROM, PROM, EPROM, or a removable CD-ROM, DVD or USB-stick. Alternatively, the computer readable medium may be a stationary device such as another computer or server, such computer or server possibly being part of a server farm, data cloud, or otherwise distributed storage facility wherein the computer program may be provided for access, e.g., download for example via a data network such as the Internet, WAN and/or LAN or a communication line such as a telephone line or wireless link.

According to a still further aspect of the present disclosure, a system for estimating a stiffness and/or an elongation of a suspension means of an elevator car is proposed. The system comprises a module configured for deriving a vibrational property of a vibrating system formed by the car and the suspension means based on a measurement of oscillating position variations resulting upon the car being temporarily accelerated; and a module configured for estimating the elongation of the suspension means based on the vibrational property.

The system can further comprise a sensor for conducting the measurement of the oscillating position variations of the car. The sensor can comprise a positioning sensor or positioning measurement system suitable for measuring changes in position of the car, particularly on small scales as discussed above, including but not limited to measurements of re-levelling. Specific examples may comprise position sensors such as photoelectric sensors, laser sensors, ultrasonic sensors, inductive sensors, magnetic sensors, capacitive sensors, but also mechanical sensors, strain sensors, etc. Additionally or alternatively, the sensor or sensors may comprise one or more velocity sensor, acceleration sensor or accelerometer, vibration or vibrational sensor, gravimeter, combination thereof, etc.

Any sensor or sensors can be configured for being arranged at a fixing point (fixed point, fix point) of the suspension means at the car, such as being attached to a mounting of a rope at the car. For example, the sensor may be integrated within a box or housing with one or more system modules, and the box may be arranged at the fixing point. According to other examples, in case of the car being suspended by multiple ropes, cables, etc., each (or some, a subset) of multiple fixing points can be equipped with a positioning sensor, an acceleration sensor, combinations thereof, etc.

It is generally to be noted that any sensor need not necessarily or exclusively be mounted or attached to the car, although this may be preferable for measuring the behavior of the vibrating car/rope system. Sensors may also or even only be placed at one or more points at the rope. While oscillatory position variations, movements or vibrations may be less pronounced as compared to measuring points directly at the car, such that a measured vibrational amplitude may appear damped, estimated results for the oscillational or vibrational frequency should coincide. Accordingly, sensor positionings at the car and/or the rope may be considered as options, where the measurement results from the various places may add to each other, complement each other, etc., depending on, for example, available space, costs for sensor attachments at the car or the rope, etc.

The stiffness and/or elongation estimation system can be implemented by one or more of data processing means, data storing means, optionally the sensory equipment discussed above, wherein the system can be arranged locally at the car and/or at remote locations, e.g., in a remote monitoring facility, wherein a local processing can include a pre-processing, such as receiving commands from remote and accordingly prepare commands for local processing, initiating and performing measurements, buffering or storing measured data, providing or sending measured data, and a remote processing can comprise any kind of post-processing on the basis of measured, intermediate or final data, for example processing to derive vibrational frequencies and/or estimate rope elongations.

As a specific example, a housing, enclosure, box, etc. can be arranged locally or on-site at the car, the box including one or more of power supply means, data communication means, data processing means, storing means for storing commands, data, such as data bases, data logs, command and measurement histories, measured data, received data, data to be sent, etc. One or more sensors may be provided within the housing or separately and connected via cable and/or wireless, for independent attachment of box and sensors to the car, the elevator shaft, the rope, etc. According to another example, in case of multiple rope fixing points at the car, each fixing point may be equipped with a box having a sensor integrated. Alternatively, one or more fixing points may be equipped with a sensor and the sensors are connected to one or more boxes arranged nearby at the car roof, at the elevator shaft near to a stop, etc.

It is to be noted that some embodiments of the invention are described herein with respect to a method for estimating a stiffness or elongation of a rope while other embodiments are described with respect to a system configured for implementing such method. One skilled in the art readily recognizes that features may suitably be transferred between these various embodiments, and features may be modified, adapted, combined and/or replaced, etc. to arrive at still further embodiments of the invention.

In the following, advantageous embodiments of the invention are described with reference to the enclosed drawings. However, neither the drawings nor the description shall be interpreted as limiting the invention.

### DESCRIPTION OF THE DRAWINGS

FIG. 1 is a functional block diagram schematically illustrating an elevator system equipped with a rope elongation estimation system according to an embodiment of the invention.

FIG. 2 schematically illustrates responses of the elevator car of FIG. 1 to the entry of a person.

FIG. 3 exemplarily illustrates sensor measurements of the responses illustrated in FIG. 2.

The figures are only schematic and not to scale. Same reference signs refer to same or similar features.

### DETAILED DESCRIPTION

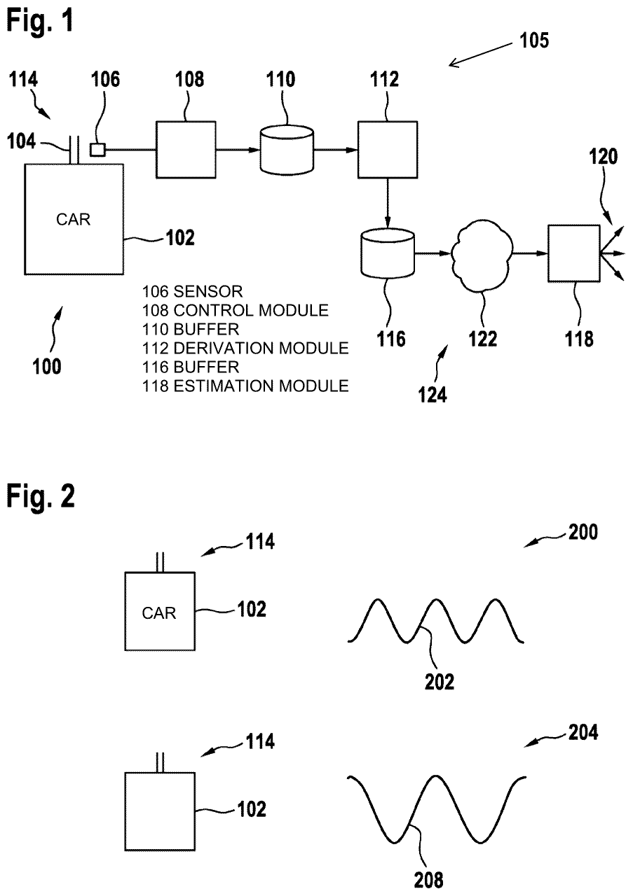

FIG. 1 schematically illustrates an embodiment of an elevator system 100 comprising an elevator car 102 suspended by suspension means which for sake of conciseness is illustrated as comprising a single rope 104. A vibration sensor 106 is arranged at a fixing point of rope 104 at car 102. For example, sensor 106 can be a single-axis accelerometer measuring accelerations/vibrations in directions along an elevator shaft (not shown) in which car 102 is moving.

Sensor 106 is controlled by a sensor control module 108. For example, module 108 can trigger sensor 106 to start a measurement each time car 102 stops, which can be determined from data provided by, e.g., also the vibration sensor 106, such as, for example, data permanently delivered from sensor 106 with a low sampling rate. A measurement intended to represent oscillatory small scale movements or positional variations of the car 102 may comprise taking data with a higher sampling rate, sensitivity, etc. for a predetermined time such as 10 sec or 30 sec, or any time span deemed sufficient for covering a typical stop of the car 102 with passengers entering and/or exiting. A typical sampling rate may, for example, be 10 Hertz (Hz) or 5 Hz, as discussed below. The control module may buffer the measurement data for further processing in a buffer 110.

A derivation module 112 is configured for deriving vibrational properties of the vibrational or vibrating system 114 formed by car 102 and rope 104. Specifically, the module 112 may calculate a vibrational frequency of system 114 from the measurement data in buffer 110, as discussed and illustrated in more detail below. A calculation may comprise identifying oscillations in the data. More specifically, oscillation events may be identified in the data, and the calculation results can include one or more corresponding oscillation frequencies. It is to be understood that the oscillations may result from excitation events such as, for example, a person or persons entering or exiting, but also from a more or less abrupt stopping of the car, of the drive sheave, from a person putting down luggage, etc. Weights or ranking values or positions may also be assigned to the identified oscillation frequencies indicating an absolute or relative power or strength of the identified oscillations, which may, for example, help identifying resonant oscillations, if any. The derivation module 112 may store its calculation result in a buffer 116.

An estimation module 118 retrieves (push or pull) the vibrational property data from buffer 116 for purposes of determining or estimating a change in oscillation frequency compared to earlier measurements, estimate a change in elongation of rope 104, and optionally an indication of the current elongation of rope 104. Data regarding a (non-) detection of a change in oscillation frequency, change in stiffness and/or elongation of the concerned rope or ropes, optionally estimates for relative/absolute values of current rope stiffness and/or elongation, may be provided to various further facilities 120 such as for presentation, storage, further processing.

FIG. 2 schematically illustrates vibrational responses of the car/rope system 114 of FIG. 1 to an excitation event, specifically an entry of a single (e.g., first) person into car 102 during a stop at a given floor. Specifically, for a first situation 200 it is assumed that at a given time point, such as at a particular calendrical date of a year, a measurement is performed under defined conditions, comprising that empty car 102 stops at the given floor, a door or doors open, and a person, such as a test person, operational personnel, etc. enters the car 102, which results in the vibrational system 114 being excited to vibrate or oscillate with a first frequency f₁ as schematically indicated by a wavetrain 202. The second situation 204 is assumed to repeat that measurement under as far as possible same or similar conditions, a test person of same weight, etc. for example one year later at the same calendrical date. The vibrational response of the car is again measured and characterized by a second frequency f₂ as indicated by a second wavetrain 208.

As illustrated by the differences in the wavetrains 202 and 208, it is considered that frequencies f₁ and f₂ differ from each other, without prejudice, due to a difference in stiffness or elongation of rope 104, as for both situations 200 and 204 conditions and other parameters of vibrational system 114 are same or similar as far as possible, which may be achieved by arranging test campaigns accordingly, or by selecting proper measurements from a set of measurements performed during normal operation for a measurement campaign lasting, e.g., for an entire day. Therefore a vibrational mass m1 may comprise the mass of one and the same car 102, one and the same portion/s of rope 104, as defined by the same given floor, and a comparable test person (e.g., any person of an average weight) entering the car 102. From the above-discussed specific example of a spring-mass formula one may expect a ratio of the rope elongations to be ε₂/ε₁=(f₁/f₂)², and a change in elongation of the rope, during the time interval between the measurements of, for example, 1 yr, can be estimated from the determined frequencies f₁, f₂.

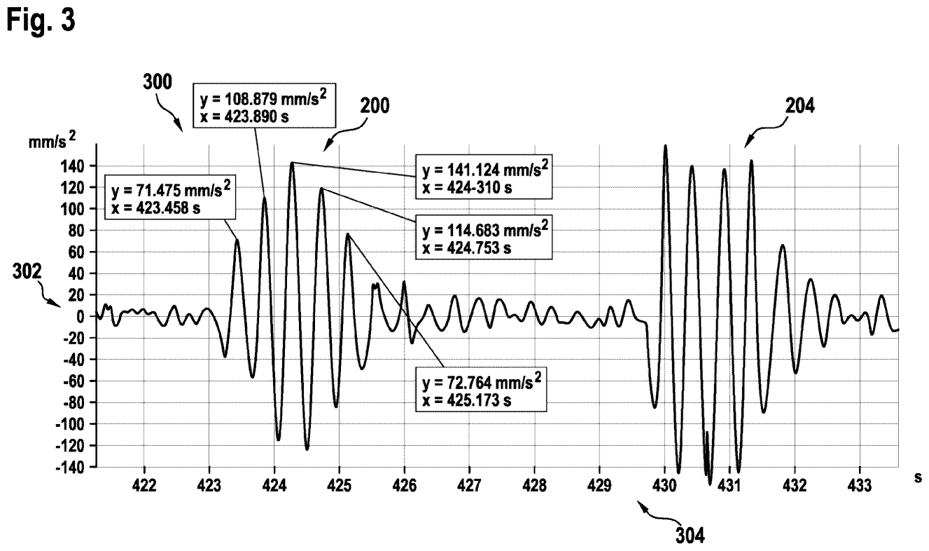

FIG. 3 is an exemplary temporary acceleration/time diagram illustrating the situations 200 and 204 of FIG. 2 as represented by associated measurements 300 in more detail. It is assumed that vibration sensor 106 (see FIG. 1) on car 102 measures vertical accelerations of the car 102, and the measurement data 302 in units of mm/s² are graphically represented along a time axis 304 in units of arbitrary seconds (422-433 s). Various time points at which local maxima of acceleration have exemplarily been identified for situation 200 are also indicated purely for purposes of illustration. From the identified local maxima (or minima, or other characteristic portions of the measurements), an oscillation frequency (or frequencies) can be derived. This is not meant to exclude other frequency detection or calculation algorithms such as on the basis of (Fast) Fourier transform mechanisms, for example.

While shown for ease of comparison on the continuous time axis 304, the data representing the situation 204 are considered to be measured reasonably later, e.g., 1 yr later as discussed above. A derivation of oscillation frequency may be performed similarly as discussed above for the measurement data representing situation 200, a change in the frequencies can be estimated, and a change in elongation of rope 104 can be estimated therefrom.

As also illustrated in FIG. 3, besides an estimation of change of oscillation frequencies one may also consider changes in oscillation amplitude, including a change in envelope of the oscillation/excitation events, wherein a subtle increase in elongation may lead not only to a decrease in oscillation or bouncing frequency, but also to an increase in amplitude and a difference in envelope. It is however to be noted that a focus on the vibrational frequency may be seen preferable, as, for example, an amplitude and/or envelope of the oscillations may be influenced by a response of a re-levelling mechanism, if present, and such influence may be different for different rope elongations, i.e., may be difficult to account for.

FIG. 3 illustrates typical car oscillations in a range of 2-3 Hz, and therefore a suitable sensor for measuring the small-scale oscillations of the car/rope system 114 may have a sampling frequency of, for example, 5 Hz or more.

It is to be noted that human walking frequencies are typically assumed to be about 2 Hz, which may be near to a natural or eigenfrequency of an elevator car/rope system, as illustrated in FIG. 3. Accordingly, the entry of a person into a car (or exit therefrom) may be considered a resonant excitation and it is therefore that measurements of oscillating position variations of the car/rope system may simply be arranged at the time of entry or exit, e.g., following a stop of the car during normal operation.

The foregoing discussion is not meant to be limiting or to exclude other explanations of technical effects and advantages of embodiments of the present invention. In fact, exciting the car or car/rope system to respond with an oscillational behavior does not require a resonant excitation such as by multiple walking steps of a person, but a single force impact or an excitation with a frequency (spectrum) other than a resonant frequency may also result in system oscillations which can be measured and analyzed, such as, for example, the stop of the car itself, or the deposition of goods or freight in the car where a relevant momentum is transferred to the car during the deposition.

Referring back to FIG. 1, the load estimation system 105 can be implemented within one or more boxes and data can be read out on maintenance inspection, for example. However, various functional modules of system 105 are suitable for being implemented in a distributed fashion. In a specific example, sensor 106, control module 108, buffer 110 and frequency derivation module 112 can be arranged locally, for example can be integrated on a single printed circuit board, PCB, which can readily be arranged at the car. It is to be noted that according to an example embodiment, a minimum sensory equipment may comprise a single (single-direction) acceleration sensor only. For example, one and the same such sensor may be used to detect a trigger event, such as the car stopping, and to then record or measure an excitation event and response thereto, such as oscillating position variations of the car resulting from temporary accelerations as to, e.g., one or more abrupt force impacts from walking steps of a person.

Further, a current vibration frequency may be calculated immediately from a measurement such that there is no need for persistently storing the measurement data, and this may also contribute to a small footprint for the local installation.

Any data in buffer 116, such as records storing a calculated or derived frequency with, e.g., a time stamp, a floor number, etc. can be stored and/or transmitted via a network 122 to a remote monitoring center 124 implementing the estimation module 118. This enables efficient remote monitoring of rope elongation, rope status, etc. of, for example, third party elevator systems.

Finally, it should be noted that the term “comprising” does not exclude other elements or steps and the “a” or “an” does not exclude a plurality. Elements described in association with different embodiments may be combined.

### LIST OF REFERENCE SIGNS

100 elevator system
102 car
104 rope
105 elongation estimation system
106 vibration sensor
108 sensor control module
110 buffer for measurement data
112 derivation module
114 vibrational system
116 buffer for resultant data
118 estimation module
120 subsequent processing
122 data transmission network
124 remote monitoring center
200 1^{st} car situation
202 1^{st} wavetrain
204 2^{nd} car situation
208 2^{nd} wavetrain
300 measurements
302 measured accelerations
304 time axis

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for estimating an elongation of a suspension means of an elevator car, the method comprising steps of:
deriving a vibrational property of a system formed by the car and the suspension means based on a measurement of oscillating position variations in the system resulting from the car being temporarily accelerated;
estimating an elongation of the suspension means based on the derived vibrational property; and
generating data indicating at least one of a current elongation of the suspension means and an estimated change in the elongation of the suspension means.

17. The method according to claim 16 wherein the oscillating position variations result upon the car being temporarily accelerated by a person entering into the car or exiting from the car.

18. The method according to claim 16 including deriving the vibrational property by calculating a resonance frequency of the system during the oscillating position variations.

19. The method according to claim 16 including deriving the vibrational property based on the system being a spring-mass system.

20. The method according to claim 19 including calculating the vibrational property according to a formula
$$f = \frac{1}{2 π} \sqrt{\frac{c}{m 1}} = \frac{1}{2 π} \sqrt{\frac{\frac{F}{ε}}{m 1}} ,$$
wherein f is a vibrational frequency of the system, c is a stiffness of the suspension means, m1 is a vibrating mass of the system, F is a force, and ε is an elongation of the suspension means.

21. The method according to claim 16 wherein the estimating an elongation of the suspension means includes estimating the change in the elongation of the suspension means based on a change in the vibrational property.

22. The method according to claim 21 wherein the estimating the change in the elongation includes estimating a change in a stiffness of the suspension means or the change in the elongation of the suspension means from measurements performed when the car stops at a same floor or at a nearby floor.

23. The method according to claim 21 wherein the estimating the change in the elongation includes estimating a change in a stiffness of the suspension means or the change in the elongation of the suspension means from measurements performed at a same car load or a comparable car load.

24. The method according to claim 21 wherein the estimating the change in the elongation includes estimating a change in a stiffness of the suspension means or the change in the elongation of the suspension means from measurements performed at a time interval selected from time intervals of at least three months, at least six months, and at least one year.

25. The method according to claim 16 including providing an indication of the estimated elongation to at least one of a remote elevator monitoring system, control system and maintenance control.

26. A computer program product comprising computer program instructions stored on a non-transitory computer-readable medium, the instructions when executed by a computing device cause the computing device to carry out the method according to claim 16.

27. A non-transitory computer-readable storage medium having stored thereon the computer program instructions according to claim 26.

28. A system for estimating an elongation of a suspension means of an elevator car, the system comprising:
a derivation module adapted to derive a vibrational property of a system formed by the car and the suspension means based on a measurement of oscillating position variations in the system resulting from the car being temporarily accelerated;
an estimation module adapted to estimate an elongation of the suspension means based on the derived vibrational property; and
wherein the estimation module generates data indicating at least one of a current elongation of the suspension means and an estimated change in the elongation of the suspension means.

29. The system according to claim 28 including a sensor generating the measurement of the oscillating position variations, the sensor being at least one of a position sensor, an acceleration sensor and a vibration sensor.

30. The system according to claim 28 including a sensor generating the measurement of the oscillating position variations, the sensor being arranged at a fixing point of the suspension means at the car.
